(19) United States
(12) Patent Application Publication
(10) Pub. No.: US 2003/0124935 A1
(43) Pub. Date: Jul. 3, 2003

(54) Scrub pad with printed rigid plates and associated methods

(76) Inventors: Nicole Smith, North St. Paul, MN (US); Young Hwa Kim, Hudson, WI (US); Hong Ji, Woodbury, MN (US); Young Lin Kim, Los Angeles, CA (US)

Correspondence Address: Steven M. Koehler, Westman, Champlin & Kelly, International Centre, Suite 1600, 900 South Second Avenue, Minneapolis, MN, 55402-3319, US

(21) Appl. No.: 10/273,409

(22) Filed: Oct. 17, 2002

Related U.S. Application Data
(63) Continuation-in-part of application No. 09/610,748, filed on Jul. 6, 2000.
(60) Provisional application No. 60/347,848, filed on Oct. 25, 2001.

(51) Int. Cl. B32B 5/26

(52) U.S. Cl. 442/239; 442/285

(57) ABSTRACT

The invention relates to a flexible scrubbing material that combines at least two discrete components. One component is a continuous flexible substrate. A second component is a discontinuous abrasive layer affixed to the flexible substrate. The abrasive layer is a set of plates formed from a material different than the continuous flexible substrate. One or two flexible substrates with affixed plates can be combined with an intermediate layer such as sponge or terry cloth. The gaps between plates are relatively large and are generally larger than one-third the largest plate dimension. The flexible substrate can be tightly woven fabric that can be printed with visually attractive colors, patterns and images. The plate material is a printable material that subsequently solidifies, such as epoxy. The inventions include associated methods of use and manufacture.

CROSS-REFERENCE TO RELATED APPLICATIONS

This application claims the benefit of U.S. Provisional Application No. 60/347,848 entitled, “SCRUBBING PAD AND METHOD FOR MAKING THE SAME” filed on Oct. 25, 2001, the content of which is incorporated herein by reference in its entirety; and this application is further a continuation-in-part and claims priority to U.S. application Ser. No. 09/610,748 entitled, “SUPPLE PENETRATION RESISTANT FABRIC AND METHOD OF MAKING” filed on Jul. 6, 2000, the content of which is incorporated herein by reference in its entirety.

### FIELD OF THE INVENTION

The present invention relates generally to scrubbing materials. In particular, the present invention relates without limitation to flexible scrubbing pads having rigid plates for use in a variety of household and industrial cleaning and personal care applications.

### BACKGROUND OF THE INVENTION

There are many different types and designs of scouring and scrub pads currently available in the marketplace. Metal wool pads, such as steel wool, have long been produced and used for household and industrial cleaning. Although these scouring pads have excellent abrasion and scouring characteristics due to the hardness of their metallic fibers, they have several significant disadvantages. For example, metallic pads are overly abrasive for surfaces that are soft, scratch easily, or subject to oxidation. Another problem associated with such pads is durability since the metal fibers have a tendency to shed and splinter while being used. Moreover, metal wool pads are harsh and uncomfortable for unprotected hands to grasp, and may lead to splinters embedded in the skin of the user. Metal wool pads also have a relatively short useful life and often rust quite readily.

In order to overcome the disadvantages of metal wool pads, many non-metallic pads have been developed. Typically, these pads comprise a non-woven web of synthetic fibers such as polyester, polyamide, polypropylene or nylon. Some examples of this structure are disclosed in U.S. Pat. Nos. 5,955,417, 5,786,065, and 4,949,417. Others comprise organic material such as sponge.

These non-metallic pads avoid many of the shortcomings of metal wool pads, but nonetheless have other limitations. For example, they may easily entrap food and other debris being removed from the surface being cleaned. This may occur because the surface of these pads is a porous non-woven web of fibers, rather than a more impenetrable surface, such as a tightly woven and/or liquid-resistant fabric. The accumulation of food may have the negative consequence of promoting bacteria growth within the pad.

Other scrubbing pads combine a woven or non-woven pad with cleansing agents and/or surfactants dispersed within the pad. One such pad is described in U.S. Pat. No. 5,955,417. The process for manufacturing such a pad includes manufacturing a three-dimensional, lofty pad and adding a dried, cleansing composition to the pad. These types of pads rely on a particular cleansing composition to enhance their cleaning performance. Also, their cleaning effectiveness gradually wanes as the cleansing composition is consumed.

Some scrub pads, such as those indicated by U.S. Pat. Nos. 3,175,331 and 4,190,550 involve the placement of a replaceable cleansing component, such as a bar of soap, within the pad to enhance cleansing effectiveness. However, the user is subject to the inconvenience of having to repeatedly replace the cleaning component as it becomes consumed.

Other scrubbing pad designs use synthetic fiber protrusions to enhance scrubbing effectiveness. For example, the scrubbing pad described in U.S. Pat. No. 5,609,431 comprises flat chisel-like tufts of synthetic fibers protruding from a backing material. One disadvantage of this type of pads is the protrusions have a tendency of losing their original shape after repeated use thereby reducing the pad's cleansing effectiveness.

There exists a need for a scrubbing pad that overcomes one, some or all of the disadvantages of prior art scrubbing pads.

### SUMMARY OF THE INVENTION

The invention relates to a sanding, scrubbing, or buffing material having a plurality of plates affixed to a flexible substrate. In one aspect of the present inventions, the scrubbing material has a first component and a second component with different properties. The first component comprises a continuous flexible substrate and a second component comprises a discontinuous layer affixed to the flexible substrate. The discontinuous layer is typically embodied as a plurality of plates. The plates comprise a resin, such as epoxy that can be printed on one or both sides of the flexible substrate by conventional printing methods and can be subsequently cured.

In another aspect of the present inventions, the substrate has two surfaces where a plurality of plates is affixed to each surface. Each substrate surface has a selected abrasion level associated with various characteristics of substrate material and affixed plates.

In yet another aspect of the present inventions, the flexible scrubbing material comprises a flexible substrate and a compressible layer or, alternately, a layer of soft, absorbent material such as terry cloth. The compressible layer can be liquid-absorbent materials, such as foam or sponge. As another aspect, the scrubbing material has a substrate and affixed plurality of plates. The plates are spaced apart so that a plurality of gaps are formed between adjacent plates. The gaps are selectively sized to provide desired characteristics such as permeability, flexibility, and abrasion level.

All of the embodiments may optionally have substrate fabrics that have visually attractive printed patterns or images that may or may not be seasonally appropriate. The embodiments can be used in wet or dry applications, i.e. with or without a liquid. The scrubbing material may be embodied as a scrub pad, sanding pad, floor buffing pad, and similar products providing an abrasive surface. Finally, the inventions also relate to methods of making the embodiments of the present invention.

### BRIEF DESCRIPTION OF THE DRAWINGS

FIG. 1 illustrates an isometric view of a scrub pad having cross-shaped plates with substrate fabric in a seasonal pattern.

FIG. 2 illustrates a diagrammatic view of a plurality of plates affixed to a substrate.

FIG. 3 illustrates a diagrammatic view of a plurality of plates in a cross pattern.

FIG. 3A is an enlarged view of a cross-shaped plate.

FIG. 3B is a sectional view taken along line 3B-3B in FIG. 3A.

FIG. 4 illustrates a diagrammatic view of a plurality of plates having plates in a dot pattern.

FIG. 5 is a picture of one side of a scrub pad having plates in a cross pattern with substrate fabric in a seasonal snowman pattern.

FIG. 5A is a picture of an enlarged portion of the scrub pad shown in FIG. 5.

FIG. 6 is a picture of the opposite side of the scrub pad shown in FIG. 5 having plates in a dot pattern with substrate fabric in a seasonal snowman pattern.

FIG. 6A is a picture of an enlarged portion of scrub pad shown in FIG. 6.

FIG. 7 illustrates an assembly view of a scrub pad having two substrate layers with two different plate patterns, an intermediate layer, seasonal patterns, and sewn seams.

FIG. 8 illustrates major steps in making scrub pad of the present invention.

### DETAILED DESCRIPTION OF THE PREFERRED EMBODIMENTS

FIG. 1 illustrates a flexible abrasive layer embodied as a scrubbing, sanding or buffing material or pad 100 on which an optional autumn pattern 102 is printed. The flexible abrasive layer 100 comprises a continuous flexible substrate 106 and discontinuous abrasive layer or plates 108 adhered on the surface 110 of the substrate 106. The substrate 106 can be a fabric or other flexible substrate. The abrasive plates 108 can be formed from a solidified material such as ultraviolet or thermally curable polymeric materials, especially epoxy material, with or without abrasive particles embedded inside.

Plates 108 are relatively flat and rigid and are designed to provide abrasive cleansing action. The design of flexible abrasive layer or scrub pad 100 utilizes two independent components, abrasive cleansing plates 108 and a flexible backing or substrate 106, to provide a scrub pad with maximum design flexibility. Hence, the substrate and plate characteristics may be chosen independently to meet various performance requirements.

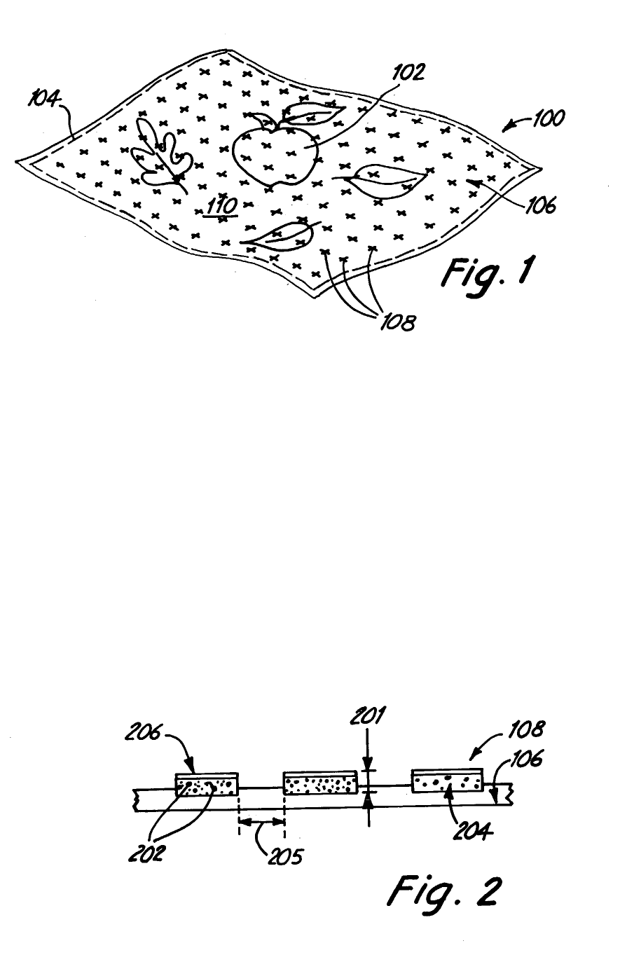

In FIG. 2, plurality of plates 108 are positioned such that a plurality of gaps 205 are formed between adjacent plates 108. The gaps 205 can be relatively large compared with the dimensions of each plate 108. Having a large gap 205 relative to the dimensions of each plate 108 is advantageous by providing increased flexibility and comfort and increased permeability to soap and liquid. Also, for most cleansing applications, plates 108 having relatively large gaps 205 provide adequate abrasion levels. In one embodiment, flexible substrate 106 is liquid-permeable but impermeable to most food particles or other debris. These characteristics provide cleansing ability while lessening the potential for bacteria growth from food particles or other debris trapped within the scrubbing pad. The flexible substrate 106 can comprise tightly woven cotton or cotton-polyester blend fabric, but other fabrics having similar characteristics can be used.

In FIG. 2 plates 108 are illustrated as partially penetrating flexible substrate 106 to securely affix plates 108 to substrate 106. The manufacturing process can utilize conventional printing methods, such as screen-printing, for printing plates 108 on flexible substrate 106. However, other methods may be used, such as roller-printing or ultra-violet (UV) etching. During printing, the plates 108 may penetrate partially or completely through substrate 106. The plates 108 are made of a printable material 204 that can be subsequently cured or solidified. For instance, the printable material 204 is a paste-like resin that at least partially penetrates and bonds with the fibers of flexible substrate 106. One example of an appropriate resin is heat-cured epoxy resin. Another example is ultra-violet cured acrylate. Ultraviolet or heat curing or some combination thereof is used to harden plates 108. The hardened plates 108 resist delaminating from flexible substrate 106 due to the integral structure formed between fibers of substrate 106 and the plates 108.

The overall abrasion level of scrubbing pad 100 may be modified by the composition of printable material 204, herein also referred to as resin. Also, the abrasion level is influenced by the curing process used. Therefore, selecting a particular resin and curing process affects the abrasion level provided by plates 108. In one embodiment, heat-cured epoxy resin has been found to have the necessary toughness as well as hardness for effective household cleaning, and yet is not prone to leaving scratch marks on many surfaces. Another example of an appropriate resin is ultra-violet (UV) cured acrylate.

Optionally, abrasive particles 202, for instance materials such as alumina or titanium dioxide, can be added to and dispersed within printable material 204 before printing. Abrasive particles 202 tend to elevate the pad's abrasion level and durability and are often used for enhanced cleansing capability, particularly when the surface to be cleansed is not prone to scratching. Optionally, plates 108 may be coated with a top coating 206 to reduce or increase the abrasion level and/or otherwise modify surface texture of plates 108. For example, a top coating of silicone reduces the abrasion level of the plates 108.

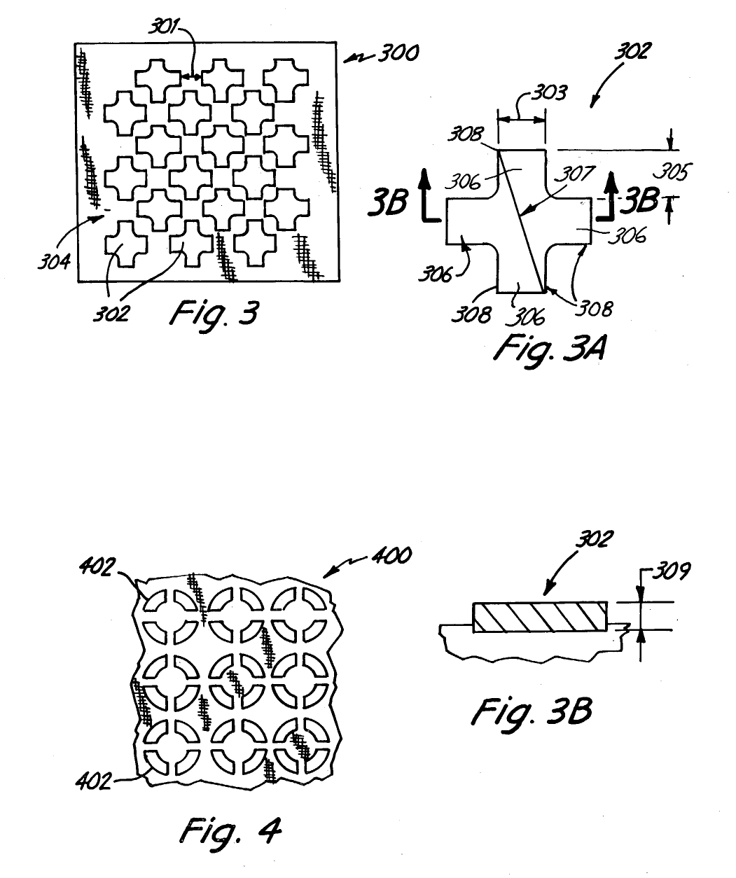

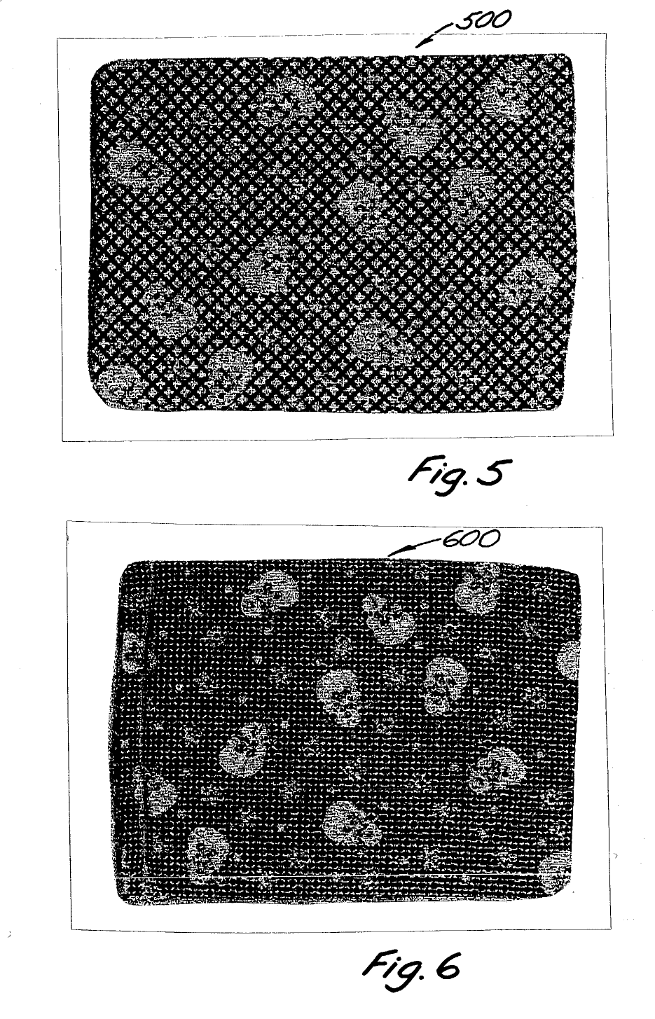

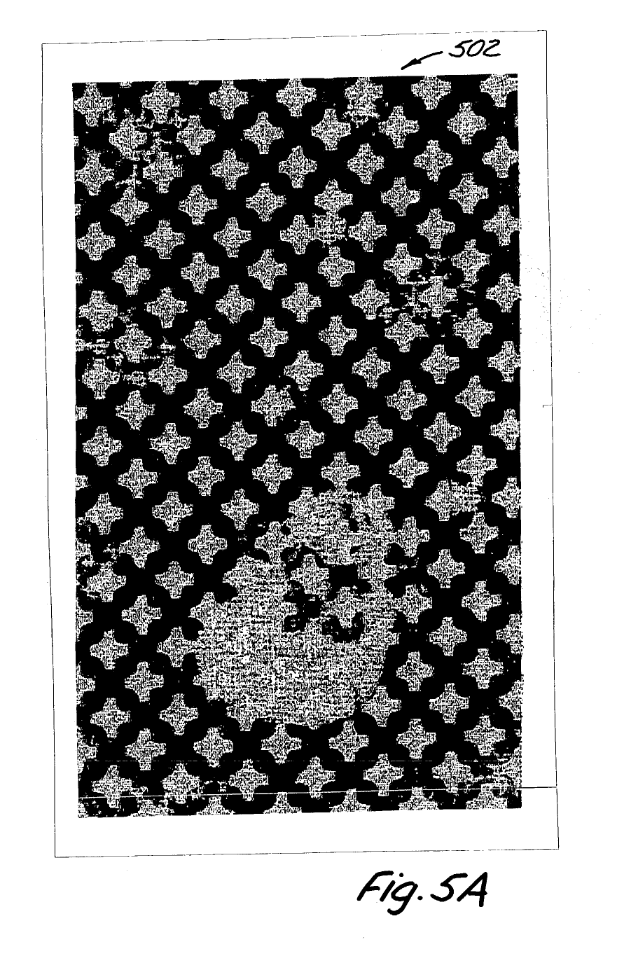

Other variables for controlling abrasion levels of plates 108 include shape, aspect ratio, gap size, and coverage area of plates 108. The possible shapes of each plate 108 include a hexagon, dot, cross and other geometric and non-geometric shapes. FIG. 3 illustrates a plurality of plates 300 where each plate 302 has a cross shape and the plates 302 are arrayed in horizontal and vertical rows in a repeating pattern. Some shapes, such as cross-shaped plates 302 have been found to provide a higher abrasion level than many other shapes, such as plurality of plates 400, where each plate 402 is elongated and dot-shaped. Plates 402 are illustrated in a repeating pattern in FIG. 4. It is noted that each plate 402 may be identical but oriented differently. For example, some plates 402 may be flipped over and/or rotated so that plates 402 form a repeating pattern, such as plurality of plates 400.

It is believed that cross-shaped plate 302 has a relatively higher abrasion level due to the plurality of sharp corners 308 on arms 306 as illustrated in FIG. 3A which is an enlarged view of plate 302. Further, in plates 302 the abrasion level also increases as the ratio of arm length 305 to arm width 303 increases. However, if the arm length 305 to arm width 303 becomes too large, plates 302 will tend to delaminate from the substrate. Therefore, selecting particular shapes for plates 108 will also vary the overall abrasion level of scrub pad 100.

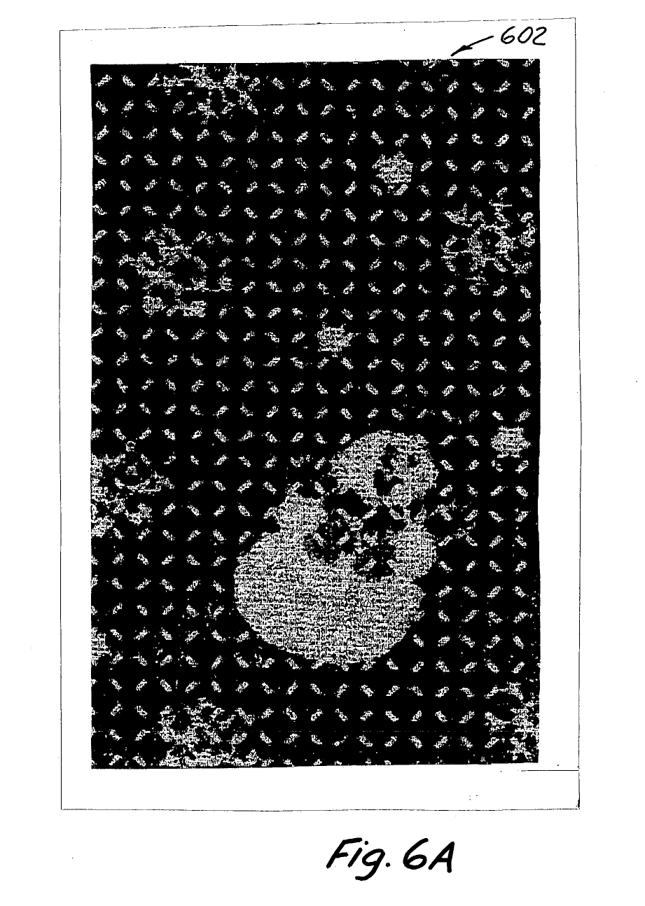

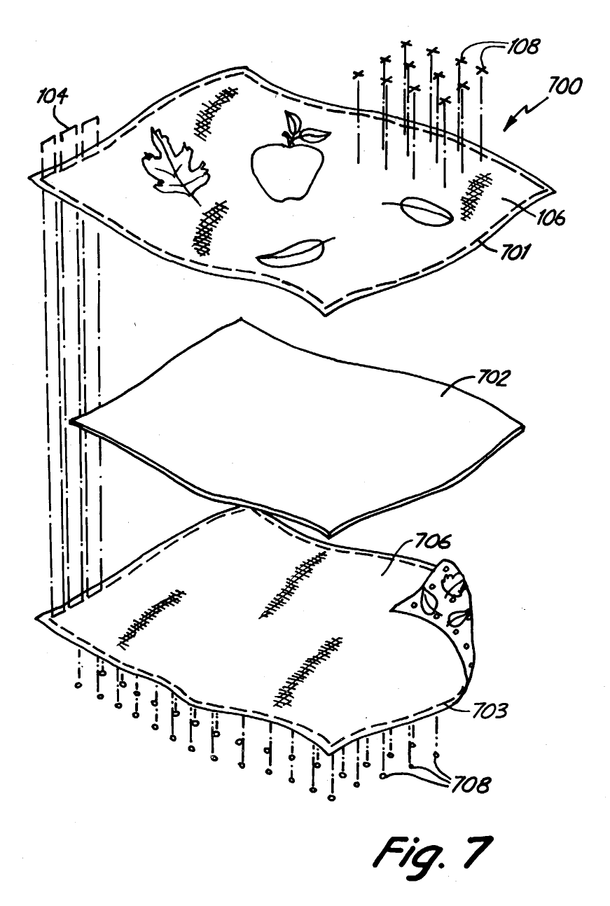

One embodiment having two surfaces 500, 600 with different abrasion levels in a seasonal snowman pattern is shown in approximate full size in FIGS. 5 and 6. FIGS. 5A and 6A are enlarged views of portions 502, 602 of surfaces 500, 600 of scrub pad shown in FIGS. 5 and 6, respectively. FIGS. 5A and 6A show the detail of the abrasive plates having different shapes and abrasion levels affixed to a substrate. It is noted that other embodiments include abrasion levels that may be equal on both sides, such as a pad 100, 500, 600, 700 having the same pattern of plates 108, 302, 402, 708 printed on both sides of pad 100, 500, 600, 700. In FIG. 5, higher abrasion side 500 is shown with cross-shaped plates in a repeating pattern similar or the same to the pattern shown in FIGS. 3 and 5A. Lower abrasion side 600 has dot-shaped plates 402 in a repeating pattern similar or the same to the pattern shown in FIGS. 4 and 6A. Substrate material is shown with a snowman pattern. Providing high abrasion side 500 and low abrasion side 600 within one scrubbing pad is advantageous due to increased flexibility in use for various situations because a user would be able to scrub one surface not particularly prone to scratching with high abrasion side 500 and turn the scrub pad over to scrub a more delicate surface with low abrasion side 600. However, in other situations having two abrasion levels that are the same is advantageous, such as when the pad will be used for the same scrubbing purpose with both sides. In these cases, having two equal abrasion levels is believed to extend the useful life of the pad.

Other techniques for varying the abrasion level of each side are discussed below. However, it should be noted that plates 108 may be identical or non-identical, and therefore, combinations of shapes can also be provided on the same side. Also, plates 108 may be arrayed in a repeating pattern, a non-repeating pattern, or positioned randomly on substrate 106.

As mentioned above, shape and aspect ratio of plates 108 also influence the abrasion level of plates 108. FIGS. 3A and 3B illustrate enlarged top and sectional views, respectively, of cross-shaped plate 302. A scrub pad 100 with plates 108, 302 having a relatively high aspect ratio is associated with a higher abrasion level. The abrasion level of scrub pad 100 can be modified by selecting a different aspect ratio of plates 108, 302, 402.

A plate's aspect ratio, as defined in the present application, is the ratio of the plate's maximum linear dimension to the plate's nominal height, where the maximum linear dimension is defined as the greatest linear distance between two points on a corresponding surface.

Therefore, for plate 302, the aspect ratio, as the term is used in the present application, is the ratio of maximum linear dimension 307 to the plate's nominal height 309. In the case of plate 302, the maximum linear dimension 302 is the distance between opposing corners 308 as illustrated in FIG. 3A. In some embodiments, the aspect ratio for plates 302 is approximately 1 to 20 although other aspect ratios can also be used. However, the nominal height of plates 302 generally does not exceed the maximum linear dimension 307 due to the greater tendency of plates 302 to delaminate as height increases.

The abrasion level of scrub pad 100 can also be adjusted by varying the coverage area of plates 108 on surface 110. In FIG. 3, surface area coverage is computed by dividing total surface area of all plates 302 by a particular substrate surface area 304 including the substrate area beneath plates 302. Higher coverage areas are associated with higher abrasion levels. In this embodiment, coverage areas range from 5% to 80% although other coverage areas can be used.

Gap size 205, 301 (shown in FIGS. 2 and 3) also affects the abrasion level of scrub pad 100. Gap size is the closest distance between adjacent plates 108, 302. In one embodiment illustrated in FIGS. 2 and 3, gap 205, 301 is greater than ⅓ the maximum linear dimension 307 which is defined above. For example, for a cross-shaped plate 302 having four arms 306, the maximum linear dimension is illustrated by reference numbers 307 in FIG. 3A. In other embodiments, the gap 205, 301 may be ½, equal to, or greater than twice, three-times, five-times, and ten-times the maximum linear dimension 307. The features described above such as abrasive particles, resin composition, aspect ratio, coverage area, and gap size allow the abrasion level of the scrub pad to be modified as required by specific application. Hence, variations of the present scrub pad may be marketed as heavy-duty, normal, or non-scratch scrub pads for industrial and household cleaning. Also, it is contemplated that the scrub pads of the present invention can be made gentle enough for human use such as cleansing skin and removing make-up.

Another desirable feature of scrub pads of the present invention is flexibility. Scrub pad flexibility, like its abrasion level, is influenced at least by plate shape and size, aspect ratio, coverage area, resin composition, gap size, and substrate fabric. Therefore, gap size and placement as well as the substrate fabric may be selected to manufacture a scrub pad having flexibility to meet performance requirements.

One benefit of gaps 205, 301 (shown in FIGS. 2 and 3) between plates 108, 302 is a relatively large area of surface 110, 304 is left exposed and visible. Therefore, it is possible to print a visually attractive pattern or image on surface 110, 304 or select a commercially available preprinted fabric. For example, scrub pad 100, 700 is illustrated in an autumn pattern in FIG. 1 and a snowman image is shown in FIGS. 5 through 7. Substrate 106, 706 can be printed in various colors, patterns, and images to be visually appealing to consumers. The designs can be seasonal, such as autumn leaves or a winter snowman pattern, or be appropriate for holidays, such as Christmas or Thanksgiving.

Scrub pad flexibility is also influenced by substrate 106, 706 particularly the type and thickness of fabric material selected. Some potential fabric types include without limitations woven, non-woven, or knit fabrics but having the ability to permit at least partial penetration of resin during printing. Fabric materials include without limitations cotton and cotton-polyester blends and other natural and man-made fabrics having similar properties.

In one embodiment, the fabric is a tightly woven cotton-polyester blend. In this embodiment, this type of fabric is used because heat-cured epoxy resin has been found to seep into and bond well with this substrate fabric. The tightly-woven cotton-polyester blend also resists penetration by food particles and other debris but permits soap and liquid to permeate through the substrate fabric for cleansing effectiveness. Finally, colorful patterns can be printed on this fabric because it absorbs ink, the ink does not tend to bleed when exposed to water, and printed patterns have relatively good resolution due partly to the fabric's tight-woven flat surface. Tightly woven cotton-polyester also does not readily shrink when washed.

FIG. 7 illustrates a diagrammatic assembly of a scrub pad 700. As in FIG. 1, scrub pad 700 has a substrate 106 and a plurality of plates 108 shown as a separate layer. Plates 108 are affixed to substrate 106 by printing as discussed above. Scrub pad 700 further comprises a second substrate 706 illustrated in a falling leaf pattern. Plates 708 are shown in a dot pattern similar to the pattern shown in FIGS. 6 and 6A. Plates 708 are affixed to substrate 706 by the printing process described for substrate 106 and plates 108, 302 above. Intermediate layer 702 is inserted and sandwiched between substrate 106 and substrate 706. In one embodiment, intermediate layer 702 is a compressible, liquid absorbent material that is flexible and soft, such as foam or sponge. Substrate 106 and substrate 706 can be loosely coupled to intermediate layer 702 by means such as sewing 104 or conventional heat sealing (not shown) along perimeter edge portions 701, 703. In another embodiment, substrates 106, 706 can be tightly coupled to intermediate layer 702 by means such as lamination.

In another embodiment, intermediate layer 702 may be joined with only one substrate 106. Intermediate layer 702 may be a soft, liquid absorbent material, but not necessarily compressible, such as but not limited to, woven or non-woven fabric with or without loops such as found in terry cloth. Another example includes flannel. Substrate 106 can be loosely or tightly coupled to intermediate layer 702, such as terry cloth, by means such as sewing or lamination but other means for coupling may be used.

In one embodiment, the substrates 106, 706 are tightly woven cotton-polyester generally permeable to liquid but impermeable to most food particles. The abrasive plates 108, 708 comprise heat-cured epoxy which are printed on both side of pad 700. Heat-cured epoxy resin inherently inhibits bacterial growth, further reducing potential bacteria growth on the pad and hence the need for a separate anti-bacterial formulation. The structure of the scrub pad 700 allows soap and liquid to soak through substrates 106, 706 and be absorbed by intermediate layer 702. The scrub pad structure is easy to rinse and clean after use. The substrates 106, 706 may be printed with attractive patterns, prints and colors. Also, they can be stitched together along their perimeter edge portions 701, 703 to enclose compressible layer 702. In another embodiment, substrate 106 can be folded over intermediate layer 702 thereby enveloping intermediate layer 702. Substrate 106 can be loosely coupled to the enveloped intermediate layer 702 by sewing along edge portion 701.

It is noted that the embodiment illustrated in FIG. 7 is not intended to be limiting. Other embodiments can be constructed with some or all of the structural elements shown in FIGS. 7 and affixed by means other than sewing or heat sealing. For instance, a scrub pad may have one substrate 106 laminated to intermediate layer 702. A scrub pad may have both substrates 106 and 706 laminated to opposite sides of intermediate layer 702. Intermediate layer 702, substrate 706, and plates 708 are features that may be eliminated as necessary for performance standards as well as cost considerations. Intermediate layer 702 may or may not be compressible. Substrate 106 can be loosely or tightly coupled to intermediate layer 702, substrate 706 or both. Similarly, patterns and images printed on substrates 106 and 706 are variable and optional.

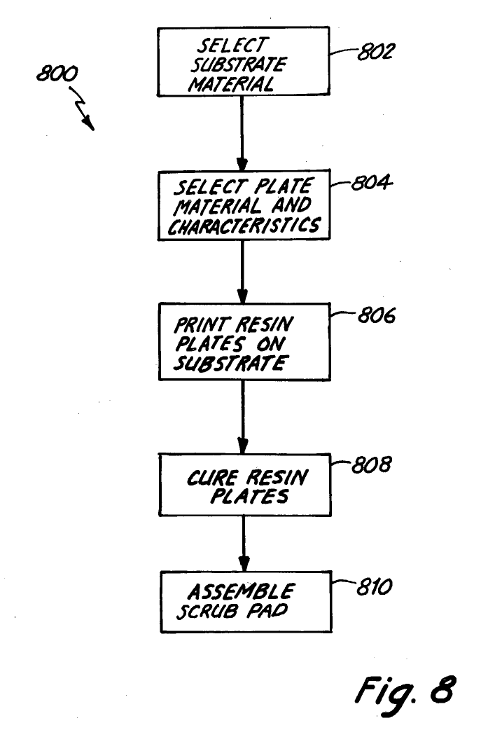

FIG. 8 illustrates steps of a typical manufacturing process 800 for manufacturing embodiments of the scrubbing or sanding pad of the present invention. Step 802 involves selecting fabric for one or both of substrates 106, 706 shown on FIGS. 1 and 7. The selected fabric has a texture that is liquid permeable, generally resistant to food particle penetration, and allows adequate physical penetration of plate resin into substrate fabric to develop a strong adhesive bond with the fabric. Typically, suitable substrate fabrics include tightly woven cotton or cotton-polyester blends, but other fabrics with similar properties are contemplated may be used. The fabric may be printed in various colors with attractive prints and images. Step 804 includes selecting appropriate resin material that forms plates 108, 708 with adequate abrasion levels. The selected resin has properties that allow plates to form that have a suitable shape and size, aspect ratio, gap size, coverage area, resolution, abrasion level and liquid and bacteria resistance as discussed above.

In one embodiment, the selected resin is the family of one-part heat-curable epoxy resins available from Fielco Industries, Inc. of Huntingdon Valley, Pa. One-part heat-curable epoxy does not cure at room temperature but must be heat-cured. Heat curing is advantageous over room temperature curing due to the longer shelf life of unused resin. The one-part formulation is also advantageous because it can eliminate the need for mixing prior to printing.

The resin material of one embodiment has an approximate viscosity of 1.61×10⁶ cps at a shear rate of 0.6 sec⁻¹ measured using a viscometer at a temperature of 87° F. This material is highly shear-thinning since at a shear rate of 12.6 sec⁻¹ the viscosity drops more than one order of magnitude to approximately 1.5×10⁵ cps. At rest, it has an apparent yield stress of approximately 75 Pa. This resin material can be printed using conventional screen printing techniques with good definition in a variety of patterns, sizes, and shapes.

Step 804 also includes selecting abrasive particles 202 illustrated in FIG. 2 to increase the abrasion level and/or durability of the scrubbing pad, if desired. Also included in step 804 is selecting coating 206, if any, shown in FIG. 2 that may modify the surface texture of plates 108, 708 shown in FIG. 7.

Step 806 is the step of printing the plates 108, 708 onto substrates 106, 706 shown in FIG. 7. A conventional screen-printing technique can be used but other techniques, such as UV etching and roller-printing can also be used. An adhesive, such as commercially available off-the-shelf spray mount adhesive, (not shown) is sprayed on the fabric. In conventional screen-printing, a template or screen (not shown) having shapes punched out is placed over each of substrates 106, 706. The punched out shapes leave voids identical in size, shape, and spacing as plates 108, 708. Paste-like resin, such as heat-curable epoxy or UV-curable acrylate, is spread over the screen to produce plates with thickness generally around 10-20 mils. The screen can use a 200-micron capillary film to develop the print pattern, and in one embodiment produces abrasive plates of thickness around 10 mils. The screens may be made of capillary films or polyester meshes. For mass production, roller printing may also be used. Printing can be on one or both sides of the substrate.

Step 808 is the step of curing the resin by heat, ultra-violet radiation, or a combination thereof. The resin plates solidify and harden on the substrate fabric during the curing process. In one embodiment, the printed resin is first individually pre-cured in an oven at 120° C. for 4-5 minutes. After pre-curing, individual substrate layers are stacked and fully cured at 120° C. for approximately one hour.

Step 810 involves assembly of individual elements into a complete scrub pad. One or two substrate layers 106, 706 with abrasive plates can be combined with an intermediate layer such as foam or a sponge to make a scrubbing pad. Alternately, a soft, liquid absorbent material such as terry cloth or a wash cloth may be used as an intermediate layer instead of the compressible layer. Typical examples of a compressible material include polyurethane or regenerated cellulose. A scrubbing pad can be assembled by stitching or sealing two substrates 106, 706 together to enclose intermediate layer 702. Alternately, one or two abrasive substrates 106, 706 may be laminated on one or both sides of intermediate layer 702 to form a scrub pad. Substrate 106 can be stitched to an intermediate layer such as terry cloth to form a scrubbing cloth.

Although the present invention has been described with reference to preferred embodiments, workers skilled in the art will recognize that changes may be made in form and detail without departing from the spirit and scope of the invention.

What is claimed is:

1. A flexible scrubbing material comprising an integration of at least two discrete components, the flexible scrubbing material comprising:
a first component comprising a continuous flexible substrate; and
a second component comprising a discontinuous abrasive layer affixed to the flexible substrate, wherein the abrasive layer comprises a plurality of abrasive plates formed from a material different than the continuous flexible substrate material.

2. The flexible scrubbing material of claim 1 further comprising:
a third component comprising a second continuous flexible substrate; and
a fourth component comprising a second plurality of plates affixed to the second continuous flexible substrate, wherein the first-mentioned plurality of plates and the second plurality of plates are opposite facing and formed of a material different than the second continuous flexible substrate material.

3. The flexible scrubbing material of claim 1 further comprising a second plurality of plates affixed to the flexible substrate opposite the first-mentioned plurality of plates, wherein the second plurality of plates is formed from a material different than the flexible substrate material.

4. The flexible scrubbing material of claim 1 further comprising a compressible layer coupled to the continuous flexible substrate.

5. The flexible scrubbing material of claim 1 wherein the continuous flexible substrate comprises tightly woven cotton-polyester.

6. The flexible scrubbing material of claim 1 wherein the plurality of abrasive plates is formed of cured polymeric material.

7. A flexible scrubbing material comprising:
a flexible substrate having a top surface and a bottom surface;
a first plurality of plates being affixed to the top surface of the flexible substrate, the first plurality of plates having associated therewith a selected first abrasion level; and
a second plurality of plates being affixed to the bottom surface of the flexible substrate, the second plurality of plates having associated therewith a selected second abrasion level.

8. The flexible scrubbing material of claim 7, wherein the second abrasion level is different than the first abrasion level.

9. The flexible scrubbing material of claim 7, wherein the second abrasion level is the same as the first abrasion level.

10. The flexible scrubbing material of claim 7 wherein the flexible substrate comprises a tightly woven fabric.

11. The flexible scrubbing material of claim 10, wherein the fabric further comprises cotton-polyester.

12. The flexible scrubbing material of claim 7, wherein the first and second pluralities of plates each comprise a printable material, the first and second pluralities of plates each at least partially penetrating the flexible substrate.

13. The flexible scrubbing material of claim 12 wherein the first plurality of plates each have a first shape associated with the first abrasion level and the second plurality of plates each have a second shape associated with a second abrasion level.

14. The flexible scrubbing material of claim 13 wherein the first and second shapes each have an aspect ratio in the approximate range of 1 to 20.

15. The flexible scrubbing material of claim 13, wherein the first plurality of plates are spaced apart so that a plurality of gaps are formed between adjacent plates, each gap being the minimum distance between two adjacent plates, and wherein the gap is greater than one third any maximum linear dimension across a corresponding surface of either of the adjacent plates.

16. The flexible scrubbing material of claim 12, wherein the printable material further comprises a plurality of abrasive particles dispersed within the printable material.

17. The flexible scrubbing material of claim 12, wherein the printable material is epoxy.

18. The flexible scrubbing material of claim 12 wherein the printable material is acrylate.

19. The flexible scrubbing material of claim 7, wherein the flexible substrate comprises a plurality of layers.

20. A flexible scrubbing material comprising:
a flexible substrate having a top surface; and
a plurality of plates being affixed to the top surface of the flexible substrate, wherein the plates are spaced apart so that a plurality of gaps are formed between adjacent plates, each gap being the minimum distance between adjacent plates, wherein each gap is greater than one third any maximum linear dimension be across a corresponding surface of either adjacent plate.

21. The flexible scrubbing material of claim 20, wherein the flexible substrate is liquid-permeable.

22. The flexible scrubbing material of claim 21, wherein the flexible substrate is a tightly woven fabric capable of preventing penetration by good particles or other debris.

23. The flexible scrubbing material of claim 22, wherein the fabric comprises cotton.

24. The flexible scrubbing pad of claim 23, wherein the fabric further comprises polyester.

25. The flexible scrubbing material of claim 20, wherein the plates comprise a printable material.

26. The flexible scrubbing material of claim 25, wherein the printable material comprises epoxy.

27. The flexible scrubbing material of claim 25, wherein the printable material comprises acrylate.

28. The flexible scrubbing material of claim 25, wherein the printable material further comprises a plurality of abrasive particles dispersed within the printable material.

29. A flexible scrubbing material comprising:
a first flexible substrate having a top surface;
a plurality of plates affixed to the top surface of the first flexible substrate; and
a intermediate layer loosely coupled to the first flexible substrate opposite the plurality of plates.

30. The flexible scrubbing material of claim 29, wherein the first flexible substrate is liquid-permeable.

31. The flexible scrubbing material of claim 30, wherein the intermediate layer is a compressible layer.

32. The flexible scrubbing material of claim 29, wherein the intermediate layer comprises terry cloth.

33. The flexible scrubbing material of claim 30, wherein the first flexible substrate comprises cotton-polyester fabric.

34. The flexible scrubbing material of claim 31, wherein the compressible layer is liquid-absorbent.

35. The flexible scrubbing material of claim 34, wherein the first flexible substrate envelopes the compressible layer.

36. The flexible scrubbing material of claim 29, further comprising a second flexible substrate, the second flexible substrate loosely coupled to the first flexible substrate wherein the compressible layer is sandwiched between the first flexible substrate and the second flexible substrate.

37. The flexible scrubbing material of claim 36, wherein the second flexible substrate further comprises a plurality of plates affixed to a surface of the second flexible substrate opposite the first flexible substrate and facing outwardly.

38. The flexible scrubbing material of claim 37 wherein the first and second flexible substrates each having a perimeter edge are attached along the perimeter edges of the first and second substrates.

39. The flexible scrubbing material of claim 38 wherein the perimeter edges of the first and second flexible substrates are attached by heat sealing.

40. The flexible scrubbing material of claim 38, wherein the perimeter edges of the first and second substrate are attached by sewing.

41. A method of scrubbing a surface comprising:
obtaining a flexible abrasive material having a top surface and a plurality of plates arrayed in a repeating pattern, the plates being affixed to the top surface of the flexible substrate;
orienting the plates against the surface to be scrubbed; and
applying pressure to the material to engage the plates against the surface to be scrubbed and simultaneously displacing the plates across the item.

42. The method of claim 41 wherein the step of applying including using a liquid between the plates and the surface to be scrubbed.

43. The method of claim 41, wherein the first-mentioned plates have associated therewith a first abrasion level and wherein the flexible substrate includes a bottom surface opposite the top surface and a second plurality of plates being affixed to the bottom surface, the second plurality of plates having associated therewith a selected second abrasion level, the second abrasion level being different than the first abrasion level of the first-mentioned plates, wherein the step of orienting includes selecting which plurality of plates to apply against the surface to be scrubbed.

44. The method of claim 41, wherein a compressible layer is coupled to the flexible substrate on a surface opposite the plurality of plates, and wherein the step of applying includes compressing the compressible layer.

45. The method of claim 41 wherein the plates are spaced apart so that a plurality of gaps are formed between adjacent plates, each gap being the minimum distance between adjacent plates, wherein each gap is greater than one third any maximum linear dimension across a corresponding surface of either adjacent plate.

46. A method of making a flexible scrubbing pad comprising:
selecting a flexible substrate having a top surface and a bottom surface;
selecting a first printable material and a second printable material;
printing the first printable material on the top surface of the flexible substrate forming a first plurality of plates, the top surface and the first plurality of plates combining to have a first abrasion level; and
printing the second printable material on the bottom surface forming a second plurality of plates, the bottom surface and the second plurality of plates combining to have a second abrasion level, wherein the first abrasion level is different from the second abrasion level.

47. A method of making a flexible scrubbing pad comprising:
selecting a flexible substrate having a top surface;
selecting a printable material;
selecting an intermediate layer;
printing the printable material on the top surface of the flexible substrate forming a plurality of plates affixed to the top surface; and
coupling the intermediate layer to the flexible substrate opposite the plurality of plates.

48. A method of making a flexible scrubbing pad comprising:
selecting a flexible substrate having a top surface;
selecting a printable material;
selecting a compressible layer; and
printing the printable material on the top surface of the flexible substrate forming a plurality of plates affixed to the top surface, wherein the plates are spaced apart so that a plurality of gaps are formed between adjacent plates, each gap being the minimum distance between adjacent plates, wherein each gap is greater than one third any maximum linear dimension across a corresponding surface of either adjacent plate.

49. A flexible scrubbing material comprising:
a flexible substrate having a top surface and a bottom surface;
a plurality of plates affixed to the top surface of the flexible substrate, wherein the plates are spaced apart so that a plurality of gaps are formed between adjacent plates, each gap being the minimum distance between adjacent plates, wherein each gap is greater than one third any maximum linear dimension across a corresponding surface of either adjacent plate; and
an intermediate layer tightly coupled to the bottom surface of the flexible substrate opposite the plurality of plates.

50. The flexible scrubbing material of claim 49 wherein the intermediate layer comprises a compressible layer.

51. The flexible fabric of claim 49 wherein the flexible substrate is laminated to the compressible layer.

52. The flexible scrubbing material of claim 51 further comprising a second flexible substrate wherein the second flexible substrate is laminated to the compressible layer opposite the first-mentioned flexible substrate.

53. The flexible scrubbing material of claim 52 wherein the second flexible substrate further comprises a plurality of plates affixed to a surface of the second flexible substrate opposite the compressible layer.

54. The flexible scrubbing material of claim 31 or 49 wherein the compressible layer is sponge.

55. The flexible scrubbing material of claim 31 or 49 wherein the compressible layer is foam.
